(19) United States
(12) Patent Application Publication
(10) Pub. No.: US 2002/0112863 A1
(43) Pub. Date: Aug. 22, 2002

(54) Automatic fire extinguisher system having an enhanced head dispersing device

(76) Inventors: Randall Padgett, Panama City, FL (US); J. Michael Pons, Panama City, FL (US)

Correspondence Address: Law Office of Larry L. Carnes, Innovation Park, 1673 West Paul Dirac Drive, Tallabassee, FL, 32310-3763, US

(21) Appl. No.: 10/020,448

(22) Filed: Oct. 29, 2001

Related U.S. Application Data
(63) Continuation-in-part of application No. 09/634,274, filed on Aug. 8, 2000, now Pat. No. 6,360,825.

(51) Int. Cl. A62C 37/00

(52) U.S. Cl. 169/56

(57) ABSTRACT

The present invention is an automatic fire extinguisher that is ideally suited for use with electric or gas stoves. The automatic fire extinguishing device is designed and configured to be removably secured to any sized commercial or residential range hood so as to offer protection by having a device that will automatically extinguish a fire safely, quickly and efficiently. The structure and design of the fire extinguisher is such that it is installed easily and will be nonobtrusive and still provide for an aesthetically pleasing hood while offering protection to the consumer. The system of the present invention comprises a hollow housing that maintains a dispersing media for extinguishing a fire. A mechanical movement device is located within the housing. The mechanical movement device is in contact with the housed media. In use, once a fire is detected, this mechanical movement device will force the housed media to the outlet and innately provide a device that can utilize any media for extinguishing a fire. This will ultimately provide a fire extinguisher that does not require servicing during its shelf life and will have a shelf life that is dependent upon the housed media.

This is a Continuation-In-Part of application no. 09/634,274 filed on Sep. 08, 2000.

### BACKGROUND OF THE INVENTION

1. Field of the Invention

The present invention relates generally to a self-contained fire extinguisher and more particularly to a self contained fire extinguisher for use with any residential or commercial range hood having a structure and design that incorporates any commercially available housed dispersing media so that the unit does not require servicing during its shelf life and will be operational and fictional regardless of the age of the particular fire extinguisher. In addition, the present invention will include a unique head dispersing device that will activate when the presence of fire is detected for enabling the housed media to be dispensed when necessary.

2. Description of the Prior Art

The use of automatically activated fire extinguishing devices is well noted in the prior art. In the event of a cooking fire such devices release a compound onto the stove surface thereby extinguishing the fire. Typically, these automatic fire-extinguishing devices are contained in the range hood of the stove exposing unsightly and bulky cable, which accumulate grease over a period of time. Additionally, such devices have been found to be unreliable, falsely activating upon sensing heat without fire. Many of these devices also require on-site installation time, as well as complex automatic shut-off of electricity or gas to the stove requiring an electrician installation, thereby adding to the stove's expense. Yet another disadvantage to the prior art devices includes an unsightly trigger mechanism that must be positioned for sensing heat from the stove.

An example of a prior art device is disclosed in U.S. Pat. No. 4,256,181 issued to Searcy. This device is a pressured fire-extinguishing vessel located in a remote station with lines to feed the range hood. This device houses a pyrotechnic sensor means that when ignited by flames transfers the fire to a fusible link. Once the fusible link is severed, a valve on the fire extinguisher is opened causing the fire extinguishing material to discharge in the location of the pyrotechnic sensor.

Another automatic fire extinguishing device is disclosed in U.S. Pat. No. 5,297,636 issued to North. This device also features a pressurized fire-extinguishing vessel. In this patent there is disclosed a residential fire extinguishing system comprising a delayed remote fire extinguisher mounted in a cabinet over the range connected by flexible hoses to a pair of nozzles housed in the hood. In the event the fire extinguisher is activated to release the fire suppressant, the gas supply line is pressurized thereby shutting off gas supply to the stove.

Yet another fire extinguishing device is disclosed in U.S. Pat. No. 5,899,278 issued to Mikulec. This device features a pressurized fire-extinguishing vessel. This patent provides for an automatically activated self contained remote station fire extinguishing stove device which is installed in a stove hood and features a compact design. In addition this patent also provides for an automatic stove shut-off.

Mikulec discovered the need of alternating and changing the structure of the conventional fire extinguisher, by providing a device that is held in a non-pressurized environment. In U.S. Pat. No. 5,992,531, Mikulec discloses a non-pressured unit that can be utilized as a conventional fire extinguisher, or in an alternative embodiment, can be utilized above the stove. In order to accomplish this type of non-pressurized configuration, Mikulec designed the interior of the unit to include a spring-loaded plunger. This will provide for the plunger to be in a compress state and allow for fluid to be stored therein. Once a fire is detected, a fusible link melts and causes the spring to be released and innately provide for the fluid to be dispensed to the appropriate location. Though efficient, this device does not effectively utilize the spring, in that the spring reaches maximum velocity prior to fully dispensing the fluid. Thus, Mikulec relies mainly on gravity for dispensing the fire retardant material A minimal amount of pressure is used and consequently, may not be adequate for dispensing the fire retardant media affectivity. In addition, Mikulec's fusible link system is complex in nature, and thus innately provides for a system that is not as economical if the design was more compact and included fewer components. Further, Mikulec discloses an attaching means, for use with conventional hoods that utilizes brackets. Though efficient, the brackets do provide for holes to be drilled in the existing cabinets and/or hood. The prospect of drilling holes may discourage some individuals from installing the unit, and thus will defeat the intended purpose of the present invention.

Yet another device which does not utilize a pressurized gas as the fire retardant material is disclosed in U.S. Pat. No. 3,773,111 issued to Dunn. In this patent there is a housing that maintains a non-pressurized fire retardant media. Located at the end of the housing is a plunger, located opposite the plunger is an outlet and located between the plunger and outlet is a housed non-pressurized media. The outlet is closed via a solder plug. When a fire is detected, the plug melts causing the housed media to be dispersed. A movement element is utilized for forcing the plunger towards an outlet end. The movement element in one embodiment is a housed pressurized air unit. Since this device uses this type of element, it must constantly be monitored for providing for an adequate amount of pressure for successfully operating the fire extinguisher. In an alternative embodiment, the movement device extends into the housed media. This design, though efficient, may be susceptible to leaks.

Accordingly, it is seen that there is a need for an automatic fire extinguishing apparatus designed and configured to operate efficiently and one that will not require servicing during its shelf life, like conventional pressurized fire extinguishers. The device should be structured so as to provide a means of automatically extinguishing a cooking fire quickly and effectively by dispersing an extinguishing media over the source of fire. This device should be compact in size, adaptable to any size range hood and optionally be adapted to be used in either a commercial or residential environment. Ideally, this apparatus should also be designed so as to allow for ease of installation and removal, so as to innately provide for a non-pressurized fire extinguishing vessel that is self-contained within range's hood. In addition, the present invention should not be limited to use in an hood, but should also be designed to replace conventional hand-held fire extinguishers, by providing a product that forces the housed media quickly and efficient and thus provide for a non-pressurized unit.

As will be seen, the present invention achieves its intended purposes, objectives and advantages by accomplishing the needs as identified above, through a new, useful and unobvious combination of component elements, which is simple to use, with the utilization of a minimum number of functioning parts, at a reasonable cost to manufacture, assemble, test and by employing only readily available material.

### SUMMARY OF THE INVENTION

The present invention is an automatic fire extinguisher that is ideally suited for use with electric or gas stoves. However, it is to be understood, by those skilled in the art, that this fire extinguisher apparatus can be used and/or attached in/to any environment/structure, so as to be adapted to extinguish flames, fires or the like when one is present. Inherently, the present invention is a fire extinguisher that can be used in combination with an electric, gas stoves and/or other applications for distinguishing fires. Thus, the present invention is a fire extinguisher that can be used in conventional form, such as a hand held unit, or optionally, can be located above a stove to provide a means of extinguishing fires.

In the preferred application, this automatic fire extinguishing device is designed and configured to successfully extinguish a fire by providing a unit that does maintaining a non-pressurized fire retard material. In order to provide for such a configuration, the present invention includes a system of the present invention comprises a hollow housing that maintains a dispersing media for extinguishing a fire. The hollow housing includes a first end and a second end. Located within the housing is the dispensing media. This media can be any commercially available media that can be used for dispensing a fire.

Located within the housing is a means for allowing the housed dispersing media to escape. This means is basically an outlet. Secured to the outlet a releasable end cap. The purpose of the end cap is to maintain the housed fire retardant media within the housing until a fire is detected. Once a fire is detected, the end cap will automatically be removed for enabling the outlet to be open and permit the housed media to be dispense for extinguishing the fire. This end cap is known as a release mechanism. It is noted that a conventional manual release mechanism can be secured to the housing.

Aiding in the release of the housed media is a mechanical movement device. In this design the mechanical movement device can aid in applying pressure to the media and thus allow for a pressurized release that does not require maintenance and will remain in its original condition and state, to innately provide for a product that will remain functional and operational regardless of its age and/or shelf life.

In essence, once a fire is detected the release mechanism is activated. This release mechanism can be automatic or, optionally, manual. Once activated, the housed dispensing media is able to escape the hollow housing via the outlet. The mechanical movement device provides the necessary force on the housed media to provide for the release to be pressurized.

For enhancing the final product, tubing or the like can be coupled to the outlet. This tubing is known as the dissipation assembly and is used to merely guide the housed media to the desired location for adequately extinguishing the fire.

In addition, an alarm system can be electrically coupled to the mechanical movement device. When the mechanical movement device is activated, such as when a fire is detected, it will activated an alarm system The alarm system will release an audible, visual, and/or combination thereof for alerting others in the area of a potential fire. This alarm system can further be coupled to the fire department, police department, security company or the like.

Conventional means, such as the use of brackets, magnets, or the like, can be utilized for securing the unit to the undersurface of the hood. Optionally, a casing can be secured to the lower surface of the hood and this casing can removably receive the housing as describe above. Thus providing for the casing to act as a holding sleeve for maintaining and securing the housing to the lower surface of the hood.

Due to the unique and simple design of the fire extinguisher of the present invention, servicing is accomplished easily, quickly and efficiently. Since the present invention does not use pressurize media, such as carbon dioxide as a propellant, as conventional fire extinguishers, charging or recharging is not necessary. Once the device has been used (a fire has been extinguished), the extinguisher is replaced or if damage has not occurred with the unit then the dispersing media can be replaced. Replacement can occur by way of a cylinder (new housing) or by filling the “exit” with the desired material.

In one embodiment, since disbursement occurs by the force of the mechanical device and not the use of carbon dioxide, the present invention alleviates all problems generally associated with conventional fire extinguishers that do utilize carbon dioxide or other propellants (nitrogen). The use of a hollow housing that can be refilled will provide for the present invention to be configured in such a manner that servicing of the fire extinguisher can be almost instantaneous, expeditious and can be easily accomplished without removal of the entire unit by simply replacing or refilling the housing.

Accordingly, it is the object of the present invention to provide an automatic fire extinguishing device which will overcome the deficiencies, shortcomings, and drawbacks of the prior fire extinguishing devices and methods thereof

A further object of the present invention is to provide for an automatic fire extinguishing device which is accomidable in both a residential or commercial cooking environment and simple in design so as to provide ease of installation and success during utilization.

Another object of the present invention, to be specifically enumerated herein, is to provide an automatic fire extinguisher device in accordance with the proceeding objects and which will conform to conventional forms of manufacture, be of simple construction and easy to use so as to provide a device that would be economically feasible, long lasting and relatively trouble free in operation.

Although there have been many automatic fire extinguishing devices, none of the inventions have become sufficiently compact, low cost, and reliable enough to become commonly used. The present invention meets the requirements of the simplified design, compact size, low initial cost, low operating cost, ease of installation and maintainability, and minimal amount of training to successfully employ the invention.

The foregoing has outlined some of the more pertinent objects of the invention. These objects should be construed to be merely illustrative of some of the more prominent features and application of the intended invention. Many other beneficial results can be obtained by applying the disclosed invention in a different manner or modifying the invention within the scope of the disclosure. Accordingly, a fuller understanding of the invention may be had by referring to the detailed description of the preferred embodiments in addition to the scope of the invention defined by the claims taken in conjunction with the accompanying drawings.

### BRIEF DESCRIPTION OF THE DRAWING

FIG. 1a is a perspective top view of the various components used in the fire extinguisher device of the present invention.

FIG. 1b is a perspective front view of the various components used in the fire extinguisher device of the present invention.

FIG. 1c is a perspective top view of the various components used in the fire extinguisher device of the present invention.

FIG. 2a is an exploded view of the components used in the fire extinguisher system of the present invention, illustrating the first embodiment of the mechanical movement device, including the tool that is used to place the mechanical device in a compressed and useable position.

FIG. 2b is an exploded view of the components used in the fire extinguisher system of the present invention, illustrating an alternative embodiment of the mechanical movement device.

FIG. 2c is an exploded view of the components used in the fire extinguisher system of the present invention, illustrating a further embodiment of the mechanical movement device.

FIG. 2d is an exploded view of the components used in the fire extinguisher system of the present invention, illustrating a further embodiment of the mechanical movement device.

FIG. 3 is an exterior view of the housing used in the fire extinguisher system of the present invention.

FIG. 4 is a side view of illustrating the interior of the housing used in the first embodiment of the fire extinguisher system of the present invention.

FIG. 5 is an enlarged perspective view of the plunger used in the fire extinguisher system of the present invention.

FIG. 6 is a perspective view of the end cap used in the fire extinguisher system of the present invention.

FIG. 7 is an alternative view of the plunger used in the fire extinguisher system of the present invention.

FIG. 8a is a side view of an alternative embodiment of a plug that can be used with the system of the present invention.

FIG. 8b is a side view of the embodiment illustrated in FIG. 8a in a non-assembled configuration.

FIG. 8c is a side view illustrating the various components that can be used to form the dissipation assembly of the present invention.

FIG. 8d is a side view of an alternative embodiment of a plug that can be used with the system of the present invention.

FIG. 9 is a perspective view of an alternative configuration for the fire extinguisher system of the present invention.

FIG. 10 is a perspective view of an alternative configuration for the fire extinguisher system of the present invention utilizing a manual means of operation.

FIG. 11 is a top view of the safety united used in the fire extinguisher system of the present invention.

FIG. 12 is a top view of the housing used in the fire extinguisher system of the present invention, illustrating an example of an attaching device that can be used with the system of the present invention.

Similar reference numerals refer to similar parts throughout the several views of the drawings.

### DESCRIPTION OF THE PREFERRED EMBODIMENT

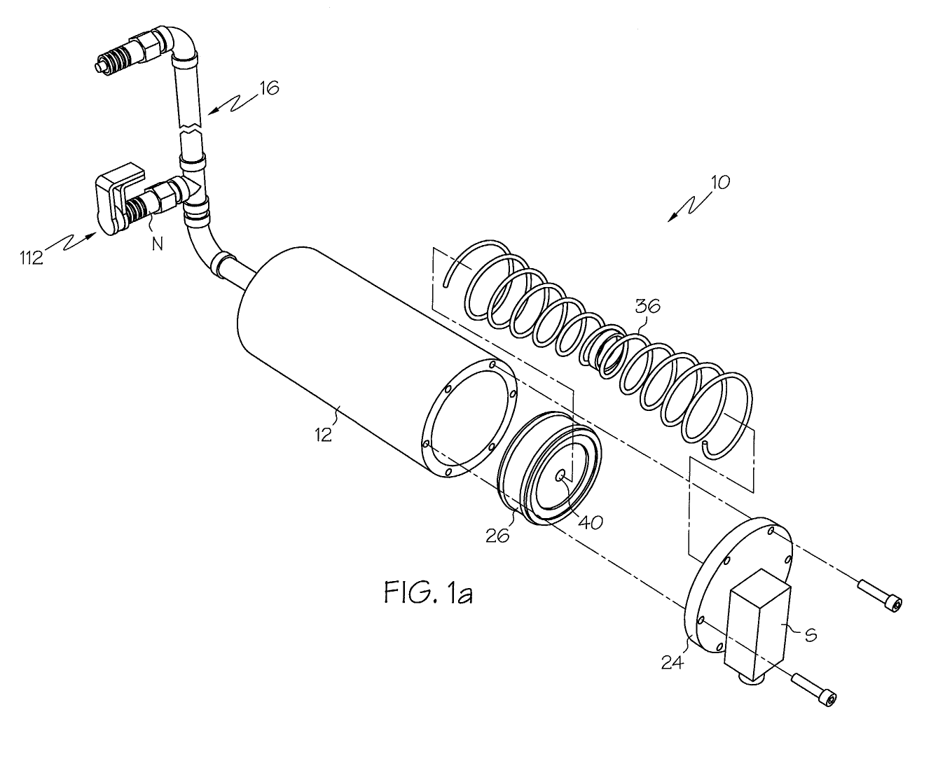

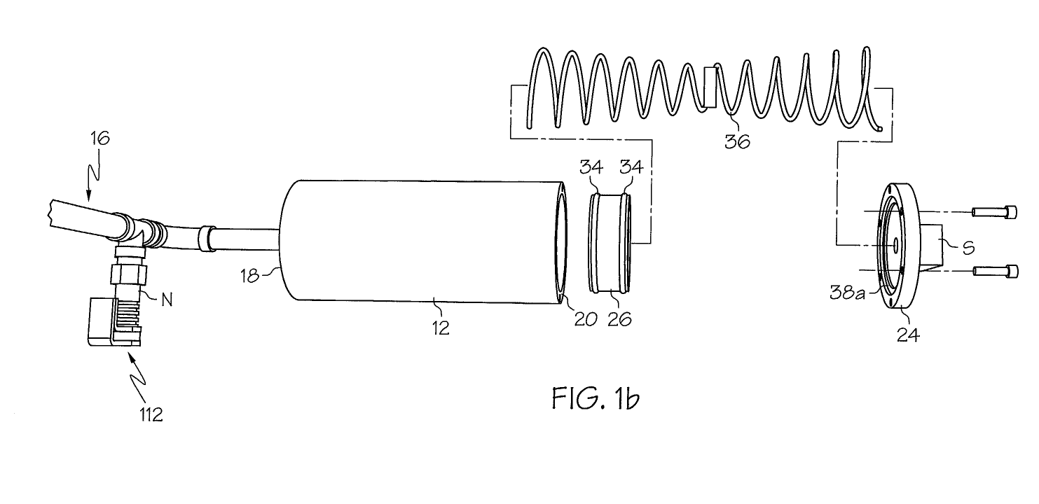

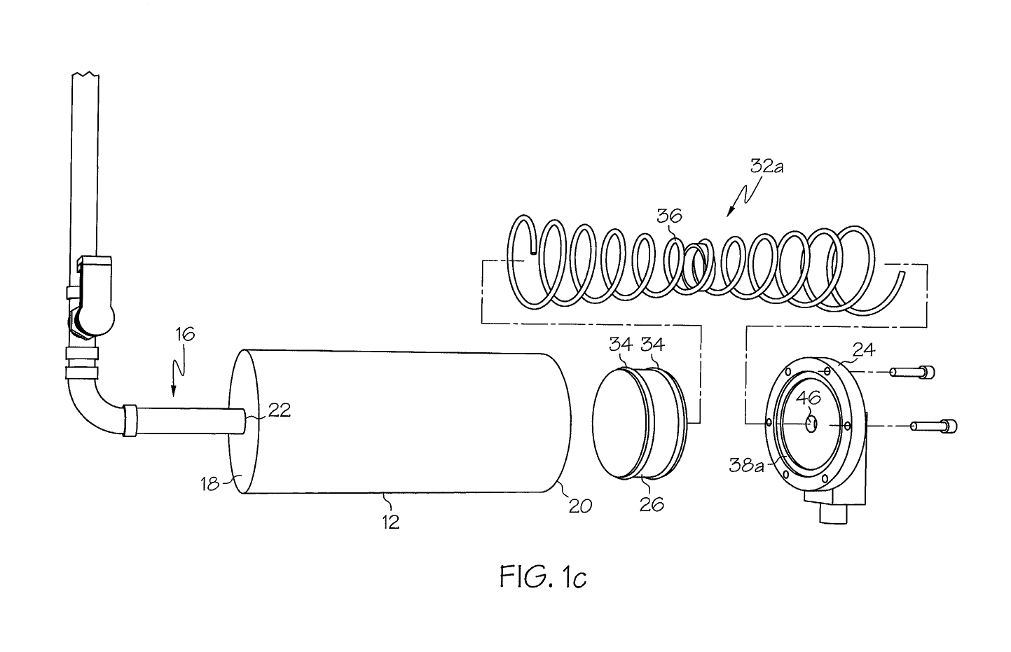

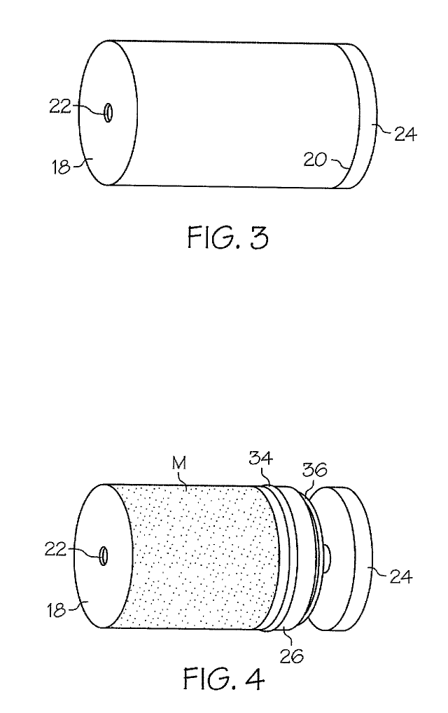

As seen in the drawings, in particular to FIGS. 1-9 there is shown a fire extinguisher system, denoted by reference numeral 10, that is designed and configured to dispense a media once a fire has developed, such as when a grease fire is located on a range, stove or the Eke. Thus the system of the present invention will be adapted as a hand held unit, such as with structures of conventional fire extinguishers or optionally as a removable unit that is secured to the undersurface of a conventional hood, so as to be accessible to the burners, yet inconspicuous, so as to be unobtrusive to the cook and/or homeowner.

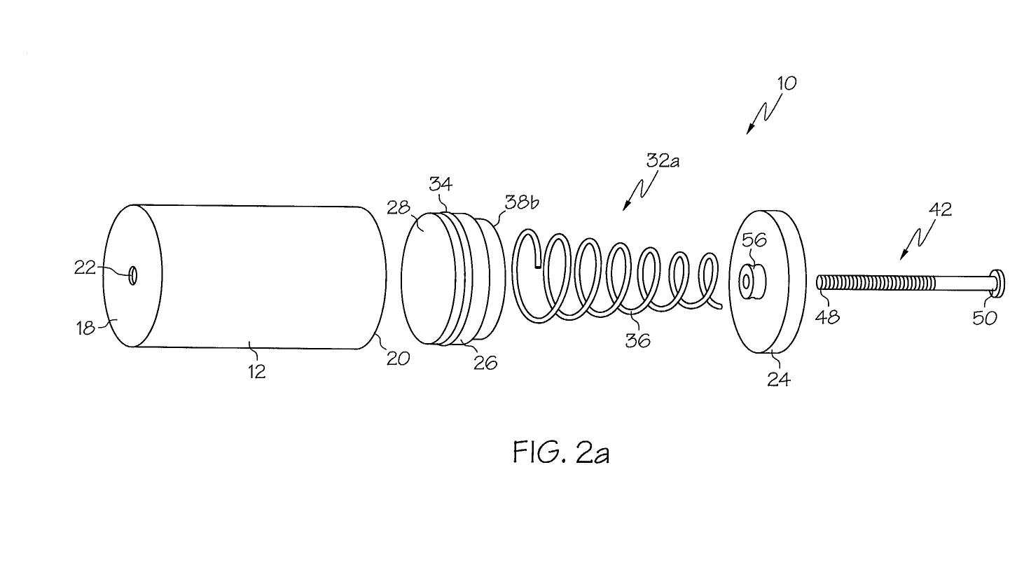

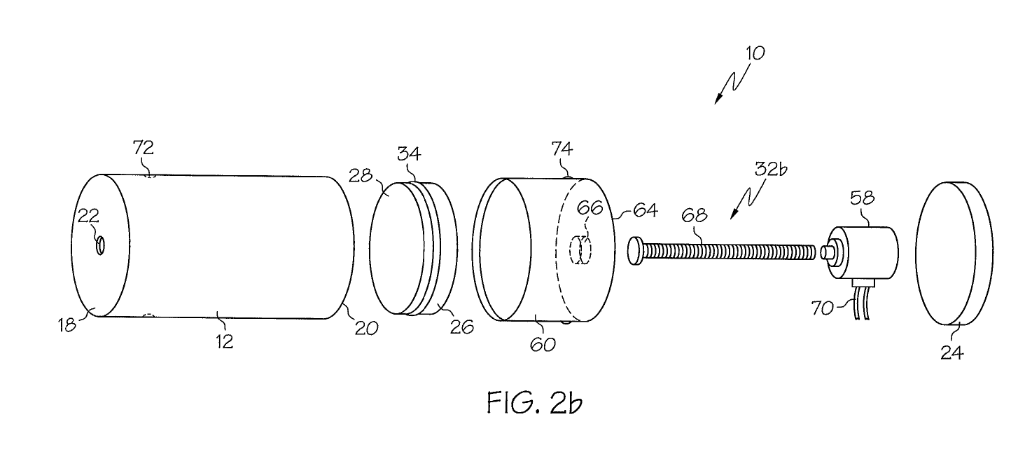

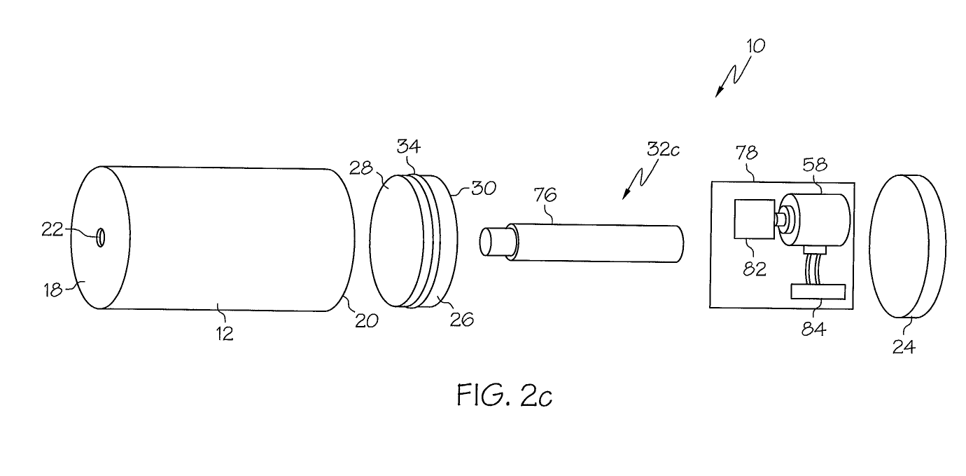

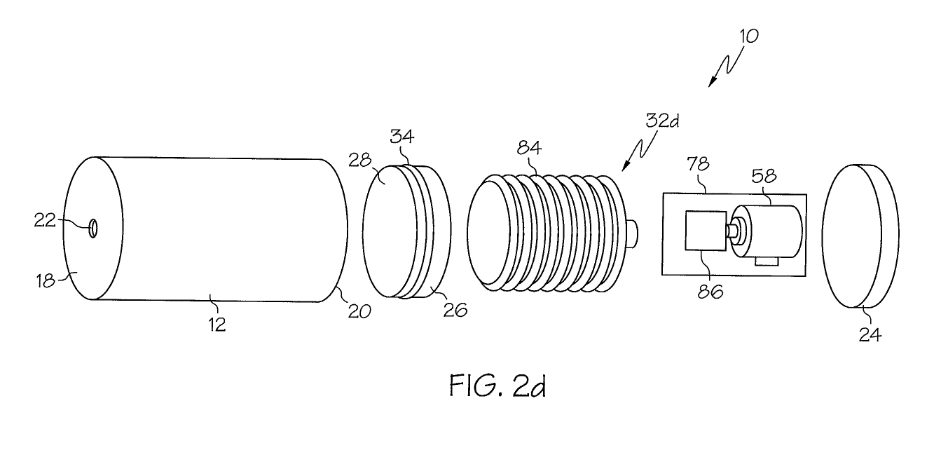

The system 10 of the present invention is suited to be attached to any surface, and is ideally designed to be attached under the hood that is located above a conventional range or the like. The attachment can be any configuration under the hood so that the present invention can be efficient at extinguishing a fire as well as be inconspicuous and functional. Being located under the hood will enable the device to activate quickly and efficiently, when a fire is detected on a stove, range or the like. In order to allow for such an arrangement, as seen in FIGS. 1a-2d, the system of the present invention comprises a housing 12, a release mechanism 14 and a dissipation assembly 16.

FIGS. 1a, 1b, 2a-2d, 3 and 4 illustrate the housing of the present invention, and as seen, the housing 12 is a hollow structure that is designed and configured to maintain the dispersing media M (illustrated in FIG. 4). This hollow housing includes a first end 18 and a second end 20. Extending through the first end is an aperture 22, which can be threaded. This aperture acts as the exit and enables the housed media M to be dispersed via this opening. When assembling the unit, this aperture 22 acts as a means of enabling the media to be placed within the hollow housing.

Coupled to this aperture 22 is the dissipation assembly 16. This dissipation assembly will direct the housed media to the particular desired location. An exteriorly threaded hollow rod can be secured to the aperture for aiding in receiving and securing the dissipation assembly 16. It is noted that this dissipation assembly includes conventional hollow conduit or plumbing material that is used for guiding and housed media to the desired location. Its shape and configuration of the dissipation assembly is governed by the location of the hollow housing 12. Located and secured to the second end 20 of the housing, as seen in is an end plate 24. Thereby providing for the housing 12 to included an enclosed end and an open end having an end cap secured thereto.

In the first embodiment of the present invention, slideably located within the housing 12, is a plunger 26. This plunger 26 is located between the exit 22 and the end plate 24 and when the system is activated, will inherently move forward, towards the first end for aiding in the disbursement of the housed media M. This forward motion will increase the pressure for dispensing the media.

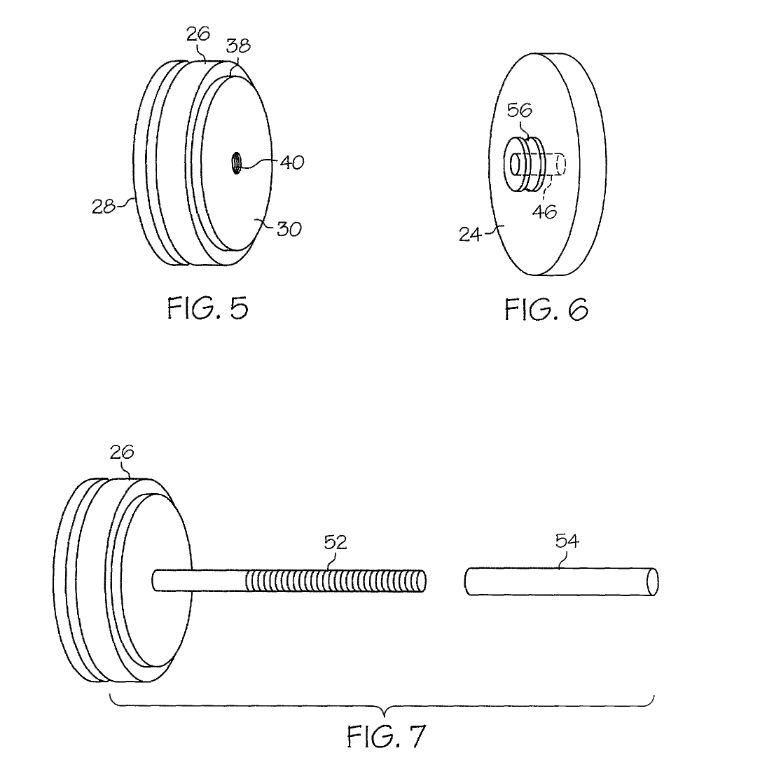

The plunger 26, has a first end 28 and a second end 30. The first end 28 will receive the media while the second end will receive a mechanical device that will push the plunger 26 towards the exit 22 of the hollow housing. Since the first end will contact a fluid, an O-ring 34 can be located therein for preventing leaks or the like. As seen in FIG. 5, a groove (illustrated, but not labeled) can be circumferencially located on the plunger 26 for adequately receiving and maintaining the O-ring 34. Preferably, two grooves can be located on the plunger so that two O-rings can be located thereon, as seen in FIGS. 1a, 1b, and 1c.

The mechanical movement device 32a, for the first embodiment of the present invention is generally a spring-loaded unit that is attached to the second end 30 of the plunger 26. This mechanical device comprises a spring 36 that is secured to the plunger 26. A recess 38a as seen in FIGS. 1a-1c, or as illustrated in FIG. 2a, a seat 38b, is located in proximity to the second end of the plunger and this recess 38a or seat 38b will receive and maintain the spring 36. Thus this will provide for the spring to be secured to the second end of the plunger.

Also located in the second end of the plunger, is a threaded opening 40, as seen in FIGS. 1b and 5. This threaded opening 38 extends partially through the plunger and will receive a threaded shaft 42 that is used for cocking the mechanical device and enabling the spring to be in a compressed position. This threaded shaft is the tool that is used for adequately cocking the mechanical device in a storable position. It is noted that this threaded opening is not necessary and is an optional feature. The second end of the plunger is dependent upon the means of which cocking or compressing the spring. The aperture can be eliminated to provide for a shaft to be permanently attached to the plunger. This shaft would include an aperture. In this design, air can be used to compress the spring, and provide for an end of the shaft to extend outward from the opening of the first end. A cotter pin or the like can be located in the aperture to provide for the spring to be in a compress state. The media can then be placed within the housing and the cotter pin can be removed once the device is installed in the desired location.

In an alternative embodiment for compressing the spring, a tool is utilized. In this embodiment, to place the mechanical movement device 32a in a useable position (spring is compressed), the end cap 24 includes an opening 46, partially illustrated in outline, extending therethrough. An elongated rod 42 is the tool that is used to compress the spring. As seen, this elongated rod includes a first end 48 and a second end 50. The first end acts as a securing device while the second end of the tool acts as the handle. To use, the first end of the tool 42 is inserted through the opening 46 of the end cap 24. The first end 48 is secured to the opening 40 of the plunger 26. Once secured, the tool is pulled back, forcing the spring to be in a compressed state. This will provide for a void to exists between the second end of the plunger and the exit of the housing. Using the exit aperture, the extinguishing media is placed therein. Once filled, the fluid will force the spring 36 to remain in a compressed state. The dissipation assembly is secured to the exit for preventing the media to escape from the interior of the housing. The tool is removed from the plunger, and the unit is ready for installation. The tool can include an aperture, as illustrated in FIG. 2a. Once the spring is compressed, via the use of a tool air or the like, the holding device, such as a cotter pin, is inserted in the aperture for providing for the spring to be in a compressed state.

In an alternative arrangement, an inlet can be located anywhere along the housing so as to provide for a separate inlet and a separate outlet. The inlet will allow for the media to be placed therein, while the media will escape via the outlet. Fusible material will be used to seal the cap to the outlet; however, fusible material will not be used for the inlet. The use of separate inlets and outlet will provide for a unit that will allow for convenient and easy means of inserting the desired material into the hollow cylinder as well as provide a means of releasing the desired media when a fire is present.

It is noted that the spring is shown to decrease in size from the attachment from the plunger to the attachment at the end cap. This configuration is ideal for allowing the spring to compress easily and quickly. In addition, due to this configuration, as the media escapes through the exit, this structure of the spring provides for a more forceful release, and thus, provides for a disbursement that is more forceful when compared to a spring without varying diameters. This conical shaped of the spring increases expansion rate when released, and thus provides for maximum velocity, and innately does not require gravity to dispense the housed media. The conical shape of the spring provides for the spring to be fully compressed. Alternatively, the spring can be shaped as two conical shaped springs wherein the area of the springs which is at the smallest diameter is coupled together, as seen in FIGS. 1a-1c.

This arrangement of the tool can be altered in configuration, and an alternative arrangement. A threaded shaft 52 can be permanently secured to the plunger. A tool 54 being interiorly threaded can be inserted through opening 46 of the end cap 24 for receiving the shaft. Once secured, the user would proceed as discussed above. It is noted that the shaft can be an internally threaded hollow shaft, and the tool can be a threaded shaft, so as to provide for the final product to be a tool that is removably secured to the plunger via any commercially available removably attaching mechanism. This tool can include the aperture as mentioned above for providing for the spring to remain compress via a cotter pin.

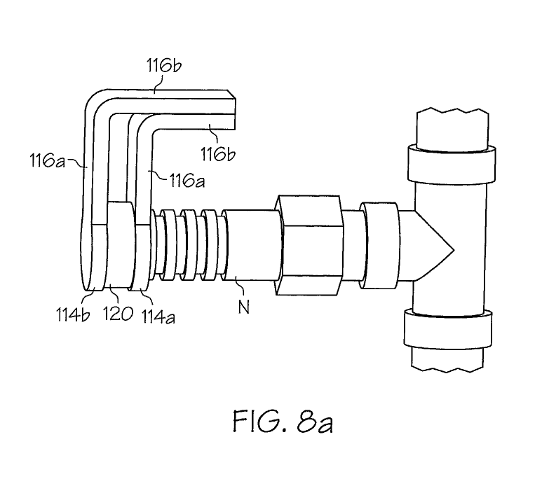

To provide for the mechanical device to be secured to both the plunger and end cap the end cap 24, like the plunger, includes a recess (illustrated in FIGS 1a-1c) or seat (illustrated in FIGS. 2a and 6). This recess or seat will receive the second end of the spring, to provide for a more secure fit between the spring and end cap.

Alternatively, the mechanical movement device can be altered to provide for a device, which is mechanical, as well as electrical in nature. This altered configuration of the mechanical movement device is shown in FIG. 2b. As seen in this figure the mechanical movement device 32b is one that is controlled via a motor 58.

The housing 12, as seen in this altered configuration, is substantially the same shape and size as the housing illustrated in FIG. 2a and thus will not be described in further detail. The plunger 26, like the housing 12, includes substantially the same shape and configuration as the plunger illustrated in FIG. 2a. Secured to the second end 30 of this plunger 26 is the mechanical movement device 32b.

One of the components of the mechanical movement device 32b of this device is a circular hollow flange 60 secured to the second end of the plunger 26. This flange and plunger can be an integral unit. As seen, the flange includes an open end 62 and an enclosed end 64. Extending through the enclosed end is an internally threaded opening 66 that acts as a lead nut.

Secured to the end cap 24 is a motor 58. This motor can be a rotary reversible electric stepping motor. A rotary reversible electric stepping motor can be used, so that if this device is accidentally activated, then the unit can be refilled by merely enabling the motor to rotate in the opposite direction, so as to enable the interior of the housing to be filled.

The motor has a rotary output shaft connected to an axially extending lead screw 68. This lead screw 68 extends centrally through the second end of the flange and is in threaded engagement with the threaded opening 66. Thus, rotation of the lead screw 68 by the motor causes the flange to be moved axially along the length of the screw and thus cause the plunger to move forward. This will force the media out of the housing when a fire is present.

Powering the motor can be accomplished by way of conventional batteries or optionally using the existing wiring within a home. In this configuration cables, illustrated, but not labeled, can be coupled to a conventional power source. The cables may supply a reduce voltage DC from a remote transformer, or may alternatively supply AC current to a transformer located with the unit of the present invention. This will provide for a transformer to be secured in the end cap and electrically coupled to the motor. The motor may be of a conventional construction and is adapted to provide a predetermine number of control pulses to effect a precise number of revolutions of the lead screw. A limit switch may be operatively connected with the motor to deactivate the motor upon contact with radially inwardly extending projections 72 forced within the housing. Thus, upon activation, the motor will rotate. The rotation of the motor will cause the lead screw to rotate. This will provide for the plunger to extend axially upwards, until contact of the limit switch 74 with the actuation projection. Coupled to the motor is the activation means. This activation means is conventional and can be any conventional type of switch or the like.

Alternatively, the mechanical movement device can be altered to provide for a device, which is hydraulic, as well as electrical in nature. This altered configuration of the mechanical movement device is shown in FIG. 2c. As seen in this figure the mechanical movement device 32c is one that is controlled via a conventional hydraulic cylinder 76 and a motor 58.

The housing 12, as seen in this altered configuration, is substantially the same shape and size as the housing illustrated in FIG. 2a and thus will not be described in further detail. The plunger 26, like the housing 12, includes substantially the same shape and configuration as the plunger illustrated in FIG. 2a. Secured to the second end 30 of this plunger 26 is the mechanical movement device.

This mechanical movement device comprises a conventional hydraulic cylinder unit 76. This conventional hydraulic cylinder unit is secured to the second end 30 of the plunger, and when in a compress state, will provide for the inner cylinder to be located within the outer cylinder (as illustrated). When in an extended position the inner cylinder will extend outward from the outer cylinder. Thus, the inner cylinder is secured to the second end of the plunger and the outer cylinder is secured to the end cap. A control unit 78 is used for activating the hydraulic cylinder. The control unit 78 includes a motor 58 coupled to an electrical valve 80. The valve is coupled to a pump 82. Lines are used to couple the pump to the hydraulic cylinder unit. Thus when activated, the motor actives the pump and the valve to open. This will allow for the hydraulic fluid to flow within the cylinder and thus allow for adequate and efficient operation to occur. Coupled to the motor is the activation means. This activation means is conventional and can be any conventional type of switch or the like.

The mechanical movement device can further include an alternative configuration that will allow for the housed media to be dispensed by the use of a pneumatic bladder. This altered configuration is shown in FIG. 2d. As seen in this figure the housing 12, as seen in this altered configuration, is substantially the same shape and size as the housing illustrated in FIG. 2a and thus will not be described in further detail. The plunger 26, like the housing 12, includes substantially the same shape and configuration as the plunger illustrated in FIGS. 1a and 2a. Secured to the second end 30 of this plunger 26 is the mechanical movement device.

The mechanical movement device 32d includes a collapsible bladder 84. The bladder is shown in FIG. 2d to be in an extended and outward position. The bladder includes a first end and a second end. The first end is coupled to the second end of the plunger while the second end is coupled to its control unit 78. The control unit includes a motor 58 coupled to a pneumatic pump 86. Thus in operation, the motor when activated, will cause the pump to activate. Upon activation, the pump will enable air to enter into the bladder. As air fills the bladder, it will force the plunger towards the exit. This will inherently cause the housed media to be forced out of the housing 12.

It is noted that the end plate 24 used in the embodiments shown in FIGS. 2b, 2c, and 2d will not include an opening nor will not include a seat. Thus, the end cap is merely a plate used to secure the electronically components utilized for the mechanical movement device shown in these figures.

A safety device, as seen in FIGS. 1a-1c and FIG. 11 can be secured to the end cap of the present invention. The purpose of the safety device is to provide for a warning means, which is audiable, visual or a combination thereof In addition, if the invention where to be used as above a stove or range, this safety can be coupled to the power of the particular appliance. In order to provide for such a configuration, the safety device includes a contact switch CS, which is in communication with the moveable plunger. The coupling means is conventional. The coupling occurs when the device is in a useable position. In this position, the spring is compressed and the end cap is in communication with a contact switch. The contact switch will be activated (turned on) when the spring is extended and the present invention is activated. Activating the contact switch will activated the warning means. In addition, the present invention can terminate power to the particular application.

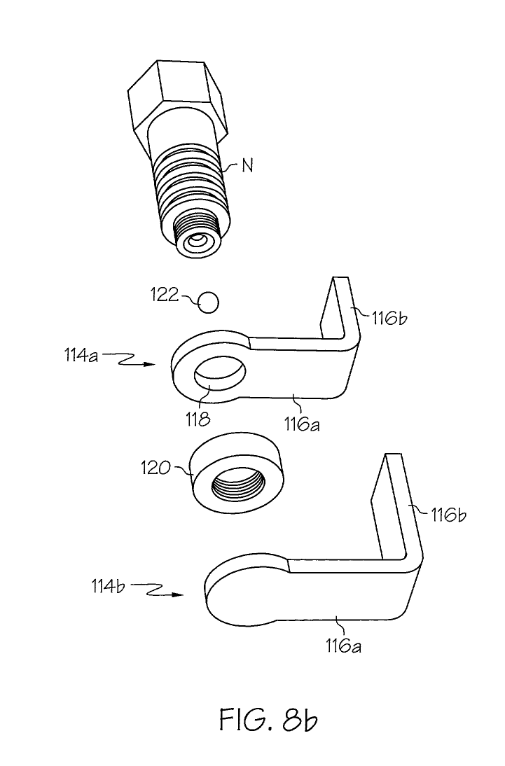

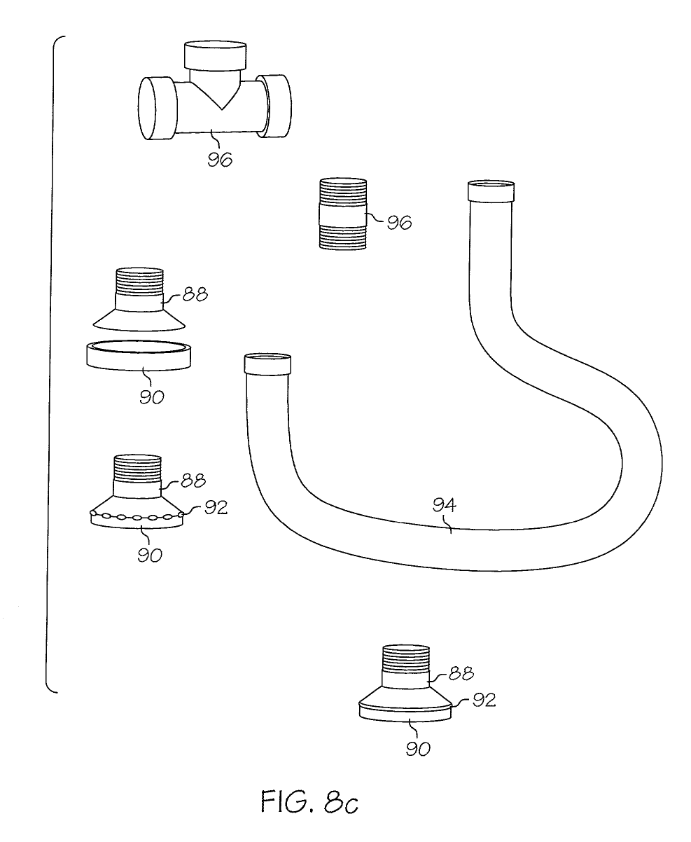

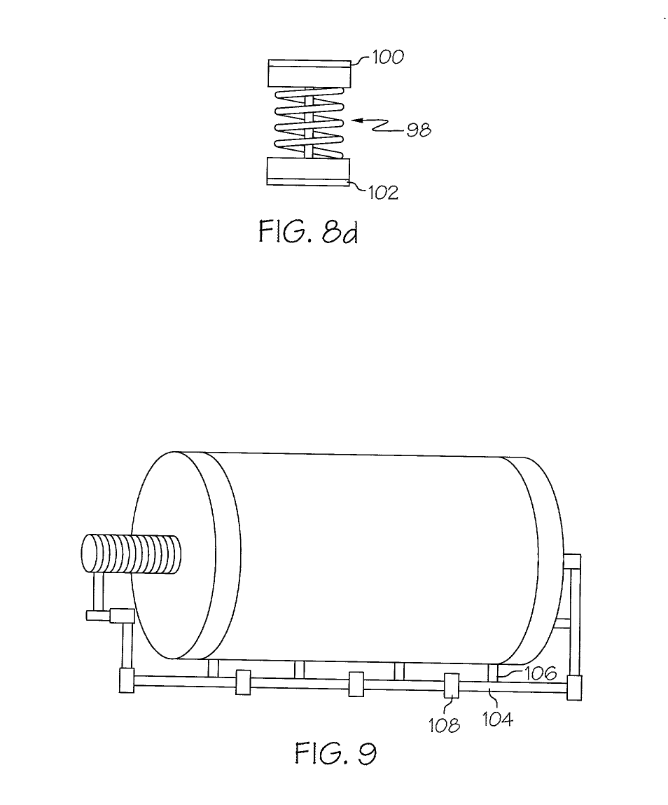

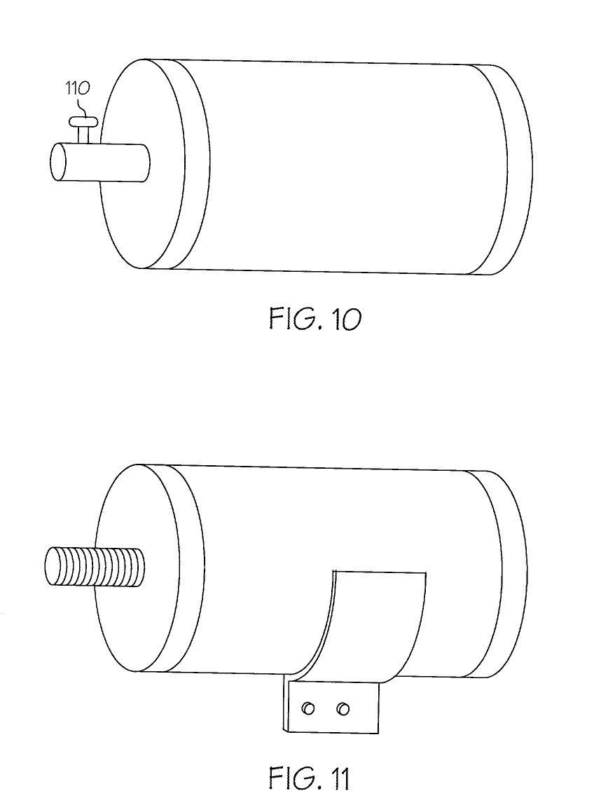

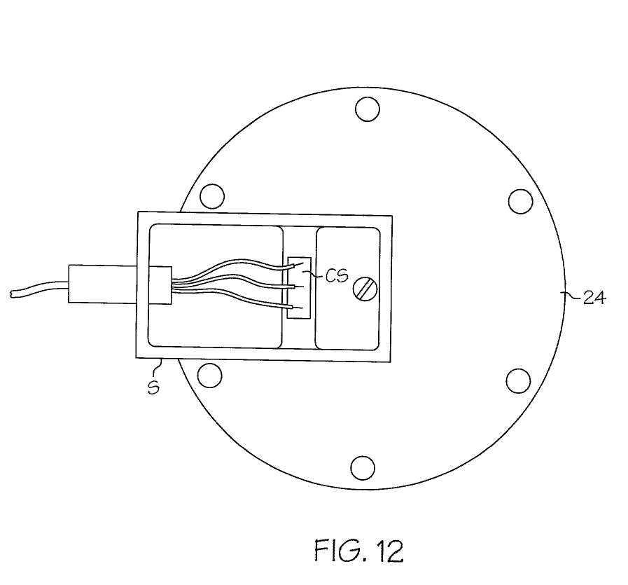

The dissipation assembly can include any design and configuration for routing the fluid to the desired location. As seen in FIGS. 1a-1c and FIG. 8c, the tubing can be as complex as including several routes or can be as simple, as seen in FIG. 10, to include a mere tube with an end cap. The tubing 56 is conventional and is designed to be routed over the range and can include as many outlets as deemed necessary by the user. The outlets 88, used for the embodiment illustrated in FIG. 2a, include a unique feature in that the end caps 90 are secured to the outlets via fusible material 92. Thus, in the presence of fire, the fusible material will melt, causing the end cap to dislodge from the outlet, and enable the fluid to escape. As the fluid is escaping, pressure is released, and the spring forces the fluid out quickly and efficiently. The fusible material used to secure the end cap to the outlet is considered the released mechanism. Inherently, providing for an automatic means of releasing the housed media in the presence of fire. It is noted that since these elements, the tubing, nozzle, and end caps are conventional, they can include any structure for mating to each other. Accordingly, the tubing, nozzle, and end caps can be threadably secured, slideably secure or the like to provide for each element to be either internally/externally threaded or be adapted to slideably receive one of the elements for mating.

For designing the dissipating assembly, tubing 94 can be used and can be coupled to connectors 96, such as T-couplers, elbows, or the like. The tubing is made of fire retardant material and can be resilient, nonresilient, and any length or diameter. The connection between the tubing and connector can occur via any forms of conventional connecting or coupling means.

For the embodiment illustrated in FIG. 2a, the novel feature for this dissipating assembly is the use of end caps that are secured to the outlets via the fusible material. The configuration of the dissipation assembly is governed by the location of the housing and the desired placement of the outlet. The more places it is desired to include outlets, the more tubing and couplings are needed. For each outlet, there will be individual end caps secured via the fusible material. The housing, tubing, connectors, and nozzles will be fabricated from a material that is resistant to fire. Only the cap of the nozzle will be secured with fusible material. Thus providing a unit that will withstand fire and one that will output a material for extinguishing a fire when present.

Alternatively allowing the housed media to escape is the use of conventional nozzles that are located and extend through the dissipating assembly. As seen in FIGS. 1a-1c, and FIGS. 8a-8b, the nozzles N can include a head 112 secured thereto for enabling the housed media to escape once a fire is present. The head 112 is desired so that it can be secured to any potential outlet of the present invention.

The head 112 as seen includes a first L-shape 114a member having a first side 116a and a second side 116b. Located at an end of the first side is an aperture 118. This aperture is designed to slide partially over the head of the nozzle. An internally threaded member 120 is placed on top of the first L-shape member and is threadably secured to the end of the conventional nozzle. A second L-shape member 114b is placed over the internally threaded member 120 and is secured to the first member via the use of solder S that is used to secured the second side of first member to the second side of the second member. Fluid can not escape, since the second member is free of openings, thereby covering the opening formed in the first L-shape member and the internally threaded member. To create watertight seal, a rubber ball 122 can be located within the opening of the nozzle.

In use, when a fire is present, the solder material melts, causing the second member to dislodge from the first member. The ball, if used, inherently fills, and the housed media is free to escape and extinguish the fire.

Thus, it is seen that installation of the unit can occur easily and efficient. The installation will be located along the undersurface of the hood, and will not take up any valuable cabinet space. The housing, couplings, tubing and nozzles are secured to the undersurface of the hood via conventional attaching elements.

Alternatively, a plug can be located within the end cap. This plug is illustrated in FIG. 8c. As seen in this figure this plug 98 includes a top area, a bottom area and a center portion located therebetween. The top area will be in communication with the housed media and thus includes an O-ring 100. The bottom portion adheres the plug to the interior of the outlet. To adhere to the interior of the outlet, a fusible material 102, such as solder is used. Accordingly, the plug is secured to the interior via the fusible material. When a fire is present, the fusible material will melt, causing the plug 98 to fall therefrom and thus allow for the housed media to escape and extinguish the fire.

A spring 104 can be located between the top and bottom portion. In this arrangement, the spring will be compressed when secured internally. Once a fire is detected, the spring will expand, as shown in FIG. 8d, and cause the plug to be released quickly, so as to allow for the housed media to be released efficiently.

For the embodiments illustrated in FIGS. 2a-2d, triggering the mechanical device can be accomplished by providing the fusible material to located in proximity to the exterior of the housing and dissipating assembly as seen in FIG. 8. In this arrangement, as shown, cable 104 is secured to the mechanical movement device. As shown, this cable runs along the side the exterior of the housing and along the length of the dissipating assembly. Guides 106 are used to aid in its securement to the assembly. Strategically placed along the path of the cable are fusible links 108. In this arrangement, when a fire is present, the links will melt, thus providing for a break to occur within the path of the cable and innately providing for the mechanical movement device to be activated.

For the embodiment illustrated in FIG. 2a, the cable would be used to maintain the spring in the compressed state. Once the fusible link breaks the cable, the spring is released from its compressible state and forces the housed media out. This will force the end, if not already released, out of the outlet and enable the housed media to extinguish the fire.

For the embodiment illustrated in FIGS. 2b, 2c and 2c, the cable can be coupled to a conventional switch, which is coupled to the motor. A break in the cable will cause the switch to activate the motor and thus activate the mechanical movement device. Operation continues as described above.

To enhance the product further, as seen in FIG. 10, a manual shut off valve 110 can be locate at the exit, along the path of the dissipation assembly, or at the outlet of the dissipation assembly. This valve will provide a mechanical means of enabling fluid to escape from the interior of the housing. The interior of the housing, in this embodiment, can have substantially the same shape and design of the interior as designed for the embodiments illustrated in FIGS. 2a and 9. Optionally, the spring and plunger assembly can be eliminated for providing a more simplified design. The use of a valve will provide for a manual release mechanism. It is noted that this valve can be used in combination with the automatic release mechanism, to enable the user to quickly extinguish a fire without waiting for the fusible material to melt.

For attaching the unit (housing, tubing, and couplings) to the desired surface, any conventional attaching means can be utilized, as seen in FIG. 11. For example, and as illustrated, conventional brackets can be used, magnets, or the like. This will offer the user any type of means necessary for adequately attaching the unit to the desired surface. Thus as seen, the brackets can be secured to the housing and secured to the brackets are magnets. Alternatively, the magnets can be secured directing to the housing.

Other features can be added to any of the embodiments above for enhancing the final product. For example, a heat shield can be added to the unit. This heat shield will be secured to the lower surface of the housing and will deflect the flames from the potential fire. This shield and/or housing can be insulated so as to provide for added protection of the unit when installed.

It is noted the mechanical movement device can be used in combination with conventional hand held fire extinguisher. This will provide a unit that will not need to be service as well as provide a unit that will operate adequately and efficiently. For enable such a unit, the conventional handle of the conventional fire extinguisher would be coupled to the mechanical movement device of the present invention. This will provide for the mechanical movement device to operate once the conventional fire extinguisher handle is depressed. Thus the conventional handle would be coupled to a switch via conventional means. Once the handle is activated switch would activate the mechanical movement device by way of either releasing the spring or optionally activating the motor.

While the invention has been particularly shown and described with reference to an embodiment thereof, it will be understood by those skilled in the art that various changes in form and detail may be made without departing from the spirit and scope of the invention.

We claim:

1. A fire extinguisher unit comprising:
a hollow housing having a first end and a second end;
said first end includes an outlet and said outlet includes an exit;
a fire sensitive head is secured to said exit;
a fire extinguishing media is stored in said hollow housing and said fire sensitive head prevents said media from escaping when there is no fire;
a mechanical movement device is located within said housing;
a plunger is located within said housing and said plunger is located between said media and said mechanical movement device and is exteriorly coupled to said mechanical movement device;
said media, when stored, forces said mechanical movement device to be a cocked and storable position;
said fire sensitive head opens said exits which allows for said mechanical movement device to move when fire is detected and when fire is detected said mechanical movement device is un-cocked and released;
said mechanical movement device forces said plunger towards said exit when a fire is detected and forces the housed media out of said housing; and
said mechanical movement device moves at a constant rate and provides for said media to travel at a constant velocity, constant pressure and flow rate.

2. A fire extinguisher unit as in claim 1 wherein a dissipating assembly is secured to said outlet for guiding said housed media once a fire is detected and said mechanical movement device is activated and said fire sensitive head is secured to outlets located within said dissipating assembly.

3. A fire extinguisher unit as in claim 1 wherein said mechanical movement device is a conical shaped spring.

4. A fire extinguisher unit as in claim 1 wherein said mechanical movement device is two conically shaped springs coupled at a point of the smallest diameter of each spring.

5. A fire extinguisher unit as in claim 2 wherein a conventional water nozzle head is secured to each outlet of said dissipating assembly, and said fire sensitive head is secured to each nozzle.

6. A fire extinguisher unit as in claim 5 wherein said fire sensitive head includes a first member, a hollow member for securing said first member and said hollow member to said conventional water nozzle head, and a second member secured to said first member via solder.

7. A fire extinguisher unit as in claim 6 wherein a ball is used to as a water seal to said an outlet of said conventional water nozzle head.

8. A fire extinguisher unit as in claim 1 wherein said plunger includes a seal for preventing said housed media from escaping.

9. A fire extinguisher unit as in claim 1 wherein said housing includes attaching device for enabling attachment to any desired surface.

10. A fire extinguisher unit as in claim 9 wherein said attaching device are magnets.

11. A fire extinguisher unit as in claim 1 wherein a conventional valve is secured to said outlet for enabling operation to occur automatically by the use of said activation device or manually via said valve.

12. A fire extinguisher unit comprising:
a hollow housing having a first end and a second end;
a fire extinguishing media is stored in said hollow housing;
said first end includes an outlet and said outlet includes an exit;
a dissipating assembly having a plurality of conventional nozzles is secured to said exit for guiding said fire extinguishing media;
a fire sensitive head is secured to each nozzle; and
when a fire is present, said fire sensitive head releases from said nozzle and enables said housed fire extinguishing media to exist and extinguish a fire.

13. A fire extinguisher unit as in claim 12 each of said fire sensitive heads includes a first member, a hollow member for securing said first member and said hollow member to said conventional water nozzle head, and a second member secured to said first member via solder.

14. A fire extinguisher unit as in claim 13 wherein a ball is used to as a water seal to said an outlet of said conventional water nozzle head.
